(19) United States
(12) Patent Application Publication
(10) Pub. No.: US 2009/0126612 A1
(43) Pub. Date: May 21, 2009

(54) Waterwheel

(75) Inventors: Simon Williams, Paisley (GB); Anthony M. Stewart, Fenwick (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Hydreau Limited

(21) Appl. No.: 11/986,504

(22) Filed: Nov. 21, 2007

(51) Int. Cl. B63B 1/00; B63B 21/24; B66D 1/00; F03B 7/00

(52) U.S. Cl. 114/61.2; 114/61.1; 114/294; 254/264; 416/243; 416/231 R; 416/23

(57) ABSTRACT

An undershot waterwheel is described. The waterwheel has a rotational axis and paddles rotatable about the rotational axis. At least one paddle comprises a blade that is curved when viewed parallel to the rotational axis. Optionally, the waterwheel may be mounted on a watercraft.

### FIELD OF THE INVENTION

The present invention relates to a waterwheel. More particularly, the invention relates to an undershot waterwheel which can be used to extract energy from a water flow.

### BACKGROUND

It is known to use a waterwheel to perform mechanical work. The waterwheel is typically located on land, next to a river. The waterwheel is rotated by water flowing in the river. The waterwheel is connected mechanically to grinding apparatus, e.g. to grind corn. An “overshot” waterwheel is a waterwheel in which incoming water is fed to the top of the waterwheel and is carried “over” the top of the waterwheel in buckets. An undershot waterwheel has paddles and is rotated by a current passing past and underneath the waterwheel, impacting on paddles at the bottom of the waterwheel.

### SUMMARY OF THE INVENTION

According to a first aspect of the invention there is provided an undershot waterwheel having a rotational axis and paddles rotatable about the rotational axis, wherein at least one paddle comprises a blade that is curved when viewed parallel to the rotational axis, and wherein the curvature is a parabola.

The parabolic curvature of the blade has the effect that, as the blade leaves the water, the portion of the blade surface at the water surface is substantially perpendicular to the water surface. This reduces the amount of water lifted by the paddle on leaving the water. Hence, the waterwheel is energy efficient. Typically, all paddles comprise curved blades. Typically, the curved blade extends over all that portion of the paddle which enters the water.

In the following description, “leading” an,d “trailing” refer to the direction of rotation of the waterwheel. The “leading face” of the blade is the downstream face when the paddle is in the water and the “trailing face” is the upstream face on which the current impacts.

Preferably, the parabola is arranged such that the trailing face of the blade is concave.

Preferably, the leading face of the blade is provided with a nose that extends from the blade. The nose smoothes the entry of the blade into the water, reducing energy loss on entry.

Preferably, the nose is located at a radially outer tip of the blade.

Typically, the nose is substantially pyramidal.

Optionally, the blade has a tip and a lower part of the blade is shaped such that h α A³, where h=distance from the blade tip and where A=surface area of the blade between the tip and that distance.

Optionally, the blade is provided with means to vary the effective surface area of the blade.

Optionally, the blade has a flap valve moveable to alter the effective surface area of the blade. Optionally, more than one flap valve is provided.

Optionally, the paddle has a cover plate extending from the trailing face of the blade. The cover plate prevents water spilling over the top of the blade as the blade enters and travels through the water.

Typically, the cover plate has vent holes to vent any air enclosed beneath the cover plate.

Optionally, the paddle includes side panels extending from the trailing face of the blade, between the cover plate and the blade. The side panels reduce passage of water past the sides of the blade as the blade enters, and travels through, the water.

Typically, the side panels are substantially triangular.

According to a second aspect of the invention there is provided a watercraft having a waterwheel according to the first aspect of the invention.

Preferably, the watercraft includes two transversely spaced hulls and the waterwheel is mounted between the two hulls. Typically, the rotational axis of the waterwheel is arranged transversely.

Preferably, the hulls are shaped such that the flowpath along the outwardly-facing sidewall of each hull is greater than the flowpath along the inwardly-facing sidewall. Thus, the hulls act as aerofoils, and the watercraft will tend to move towards the fastest flowing current, keeping the watercraft in an optimum position to obtain a large amount of power from the current, within the limits of any tethered restraint.

Optionally, at the front of the watercraft, the hulls are shaped such that the separation of the inwardly-facing sidewalls of the hulls decreases with distance towards the waterwheel.

Optionally, at the rear of the watercraft, the hulls are shaped such that the separation of the inwardly-facing sidewalls of the hulls increases with distance away from the waterwheel.

Typically, the watercraft includes lifting apparatus adapted to raise and lower the waterwheel, such that the extent of submersion of the waterwheel can be varied.

Preferably, the watercraft includes a control system adapted to operate the lifting apparatus to raise and lower the waterwheel in dependence on a feedback signal from a load. The control system may be provided on the watercraft or separate from the watercraft.

Optionally, the watercraft includes a hydraulic pump, and the waterwheel is arranged to drive the hydraulic pump.

Typically, the watercraft includes hydraulic transmission conduits and a submersible hydraulic coupling.

Optionally, the submersible hydraulic coupling comprises a free rotational hydraulic coupling adapted for rotation through 360°.

Optionally, the watercraft includes an anchor and at least one tether, and the tether is adapted, in use, to support at least one of the hydraulic transmission conduits.

Optionally, the watercraft includes a pulley system adapted to couple the hydraulic coupling to the anchor, and the pulley system is operable to raise and lower the hydraulic coupling. Optionally, a buoy could be attached to the pulley and the buoy could be arranged as a release mechanism to operate the pulley to raise the hydraulic coupling.

According to a third aspect of the invention there is provided an undershot waterwheel having a rotational axis and paddles rotatable about the rotational axis, wherein at least one paddle comprises a blade, and wherein a leading surface of the blade is provided with a nose that extends from the blade.

Optionally, the waterwheel of the third aspect of the invention includes any feature of the waterwheel of the first aspect of the invention.

According to a fourth aspect of the invention there is provided a watercraft having two transversely spaced hulls and an undershot waterwheel mounted between the two hulls, wherein the hulls are shaped such that the flowpath along the outwardly-facing sidewall of each hull is greater than the flowpath along the inwardly-facing sidewall. Hence, not all embodiments require paddles of a particular shape.

According to a fifth aspect of the invention there is provided an undershot waterwheel having a rotational axis and paddles rotatable about the rotational axis, wherein at least one paddle comprises a blade that is curved when viewed parallel to the rotational axis, and wherein the curvature is such as to reduce lift of water on exit of the blade from the water. Hence, not all embodiments of the invention require a parabolic curvature.

### BRIEF DESCRIPTION OF THE DRAWINGS

An embodiment of the invention will now be described, by way of example only, and with reference to the following drawings, in which:

FIG. 1 shows a perspective view of a paddle of a waterwheel of the present invention;

FIG. 2 shows a cross-sectional view of the paddle of FIG. 1;

FIG. 3 shows a side view of the paddle of FIG. 1;

FIG. 4 shows a perspective view of a nose of the paddle of FIG. 1;

FIG. 5 shows a view of part of a leading face of the paddle of FIG. 1;

FIG. 6 shows a view of a trailing face of the paddle of FIG. 1;

FIG. 7 shows a graph of distance from the paddle tip “h” vs. distance across the paddle “x” of FIG. 1;

FIG. 8 shows a view of part of the trailing face of the paddle of FIG. 1;

FIG. 9 shows a side view of the paddle of FIG. 1;

FIG. 10 shows a plan view of a watercraft having a waterwheel of the present invention;

FIG. 11 shows a side view of part of the watercraft of FIG. 10; and

FIG. 12 shows a schematic drawing of the watercraft of FIG. 10 arranged to power a system.

### DETAILED DESCRIPTION OF THE INVENTION

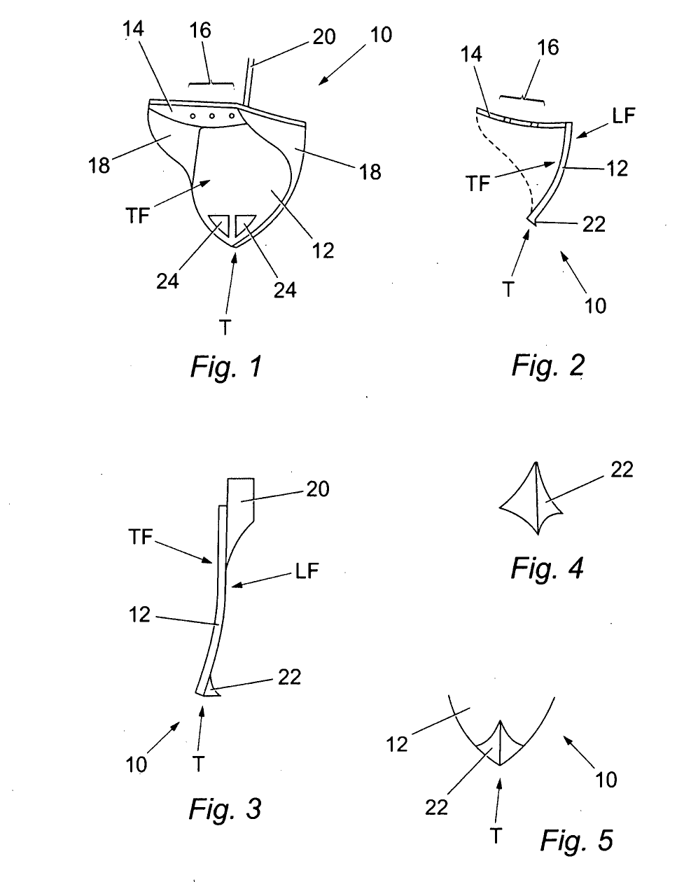

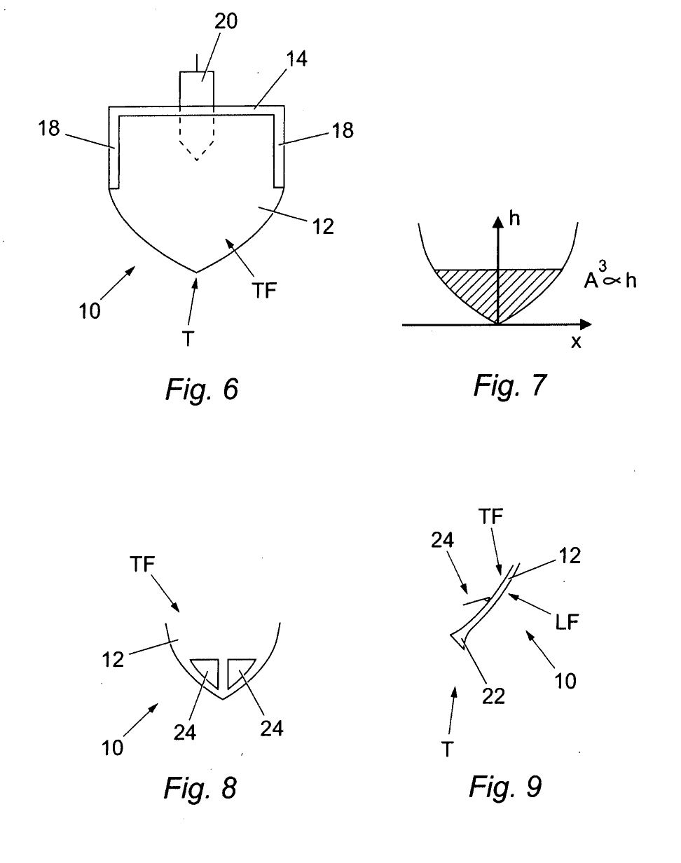

FIGS. 1 to 9 show a paddle 10 of an undershot waterwheel 100. The paddle 10 includes a blade 12, which has a leading face LF and a trailing face TF. As shown in FIGS. 2 and 3, the blade 12 is curved when viewed parallel to the axis of rotation of the waterwheel 100. The curve is a parabola. The curvature causes the amount of water lifted by the paddle 10 on leaving the water to be reduced; hence, the waterwheel 100 is energy efficient. A parabolic curvature is particularly efficient in this respect.

The paddle 10 also includes a cover plate 14 that extends from the trailing face TF of the blade 12. The cover plate 14 encloses the top of the blade 12 radially, to reduce spillage of water over the top of the blade 12. The cover plate 14 does not necessarily fully enclose the paddle 10. In this embodiment, the cover plate 14 is an awning-type lateral extension, only fixed to the blade 12 along one edge. In use, when the paddle 10 enters the water, the current impacts the trailing face TF of the blade 12, and is hindered from travelling further over the top of the blade 12 by the cover plate 14. Hence, water pressure builds up between the trailing face TF of the blade 12 and the cover plate 14. The pressure causes the waterwheel 100 to rotate to allow the current past the blade 12. Maximum power is produced when, on submergence of the blade 12, the surface of the water reaches the cover plate 14 of the blade 12.

The cover plate 14 has vent holes 16, to vent any air enclosed beneath the cover plate 14, preventing a vacuum forming as the paddle 10 rises from the water.

The paddle 10 also includes side panels 18 that extend from the trailing face TF of the blade 12, between the cover plate 14 and the blade 12. The side panels 18 reduce passage of water past the sides of the paddles 10, on entry to the water, and as the paddles 10 travel through the water. The side panels 18 are substantially triangular. “Substantially triangular”, does not necessarily mean exactly triangular, and in particular, the hypotenuse side may be curved, as shown in FIG. 1. Substantially triangular side panels 18 ensure high power transfer to the paddles 10, with low weight and drag.

The paddle 10 is attached to the rest of the waterwheel 100 by spoke 20.

The blade 12 has a radially outer tip T, and the lower part of the blade 12 is shaped such that h α A³, where h=distance from the blade tip, and where A=the surface area of the blade 12 between the tip and that distance. The power generated by a paddle 10 is proportional to the cube of the submerged area of the paddle 10, i.e. Power α area³. Thus, since h α area³, and Power α area³, therefore h α power; i.e. the power generated by the waterwheel 100 is directly proportional to the submerged depth of the paddles 10. This greatly simplifies power regulation, as no complex calculations are needed. For example, if twice as much power is required, the vertical submersion distance of the paddles 10 must be doubled. A graph of distance from the blade tip “h” against distance across the blade “x” is shown in FIG. 7. “A” is represented by the shaded part of the graph.

A nose 22 is provided on the leading face LF of the blade 12, at the tip T. The nose 22 extends from the blade 12. The nose 22 smoothes the entry of the blade 12 into the water, reducing the energy loss on entry. The nose 22 is substantially pyramidal, with slightly concave outer faces; see FIG. 4.

As shown in FIGS. 8 and 9, the blade 12 has two flap valves 24, mounted on (e.g. hinged to) the trailing face TF of the blade 12.

The flap valves 24 are a means to vary the effective surface area of the blade 12. The flap valves 24 tend to be open until water pushes against the blade 12. On entry of the blade 12 into the water, the flap valves 24 are open, and the effective surface area of the blade 12 is reduced. Hence, water resistance to the blade 12 is low on entry, reducing energy losses. The waterwheel 100 rotates and the blade 12 moves into a position where the current pushes on the blade 12 and shuts the flap valves 24. Thus, the current impacts the entire blade area. Hence, the flap valves 24 increase the efficiency of the waterwheel 100.

Alternative embodiments of the invention do not include flap valves. Such embodiments are simpler, with fewer moving parts, and may be more durable.

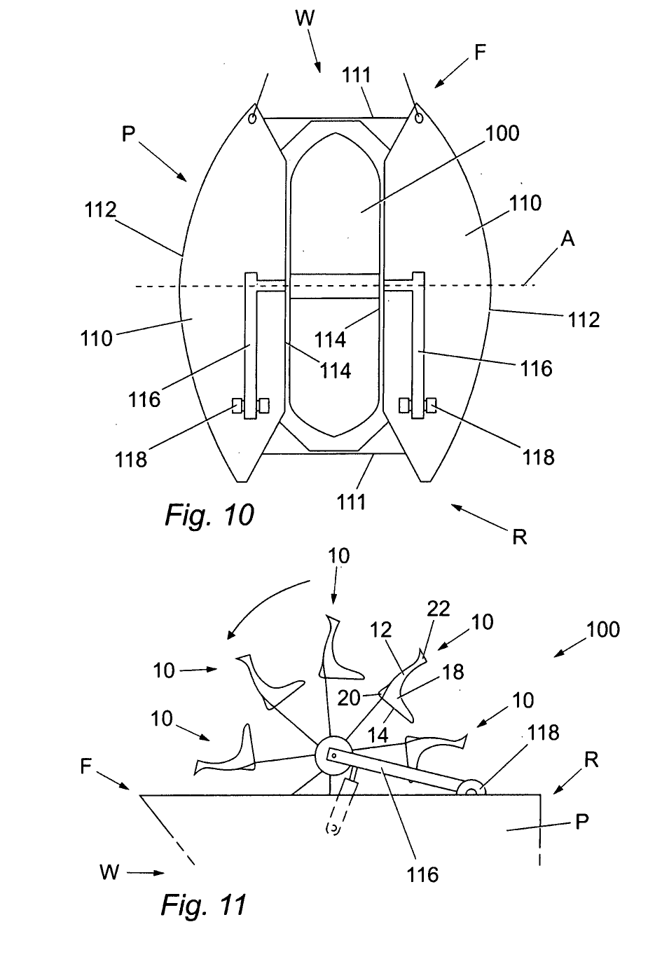

The waterwheel 100 may be located on land, but in this embodiment, the waterwheel 100 is mounted on a watercraft in the form of a pontoon P, see FIGS. 10-12. The waterwheel 100 may alternatively be located on other forms of watercraft, e.g. on a raft.

Referring to FIGS. 10 and 11, the pontoon P has a front F, a rear R and includes two transversely spaced hulls 110, the waterwheel 100 being mounted between the two hulls 110. “Transversely spaced” means that the hulls 110 are side by side. The current direction W is also shown.

The waterwheel 100 is typically approximately 2 m or less in length, and around 1 m in diameter; however, these dimensions are merely examples and do not limit the invention.

Each hull 110 contains a ballast chamber fore and aft to allow the pontoon P to be trimmed to the correct floatation depth in all planar dimensions. That is, the hulls 110 can be trimmed horizontal and at the correct depth and each hull can be so trimmed to ensure the pontoon P rides correctly to allow optimum penetration of the waterwheel 100 into the water.

The hulls 110 are held together by front and rear triangulation plates 111 (e.g. of carbon fibre) to prevent “parallelogram” deformation.

The hulls 110 have outwardly-facing sidewalls 112 and inwardly-facing sidewalls 114. The flowpath along the outwardly-facing sidewall 112 of each hull 110 is greater than the flowpath along the inwardly-facing sidewall 114. Thus, the hulls 110 act as aerofoils, and the pontoon P will tend to move towards the fastest flowing current, keeping the pontoon P in an optimum position to obtain a large amount of power from the current, within the limits of any tethered restraint. To achieve this aerofoil effect, the difference in length between the outwardly-facing sidewalls 112 and the inwardly-facing sidewalls 114 is not necessarily large. For example, a 2-3 cm difference in length is sufficient.

The waterwheel 100 has only a small clearance with the inwardly-facing sidewalls 114, so that substantially all of the water passing between the hulls 110 is directed onto the waterwheel 100.

The hulls 110 have tapered ends. In particular, at the front F of the pontoon P, the separation of the inwardly-facing sidewalls 112 of the hulls 110 decreases with distance towards the waterwheel 100. This allows the front F of the pontoon P to act as a venturi. The large separation of the front of the hulls 110 (the bows) embraces a large amount of water, which is then forced into a smaller space. This causes the water level between the bows of the hulls 110 to be raised relative to the surrounding water, causing additional pressure on the waterwheel 100, and hence additional power output.

At the rear R of the pontoon P, the separation of the inwardly-facing sidewalls 112 of the hulls 110 increases with distance away from the waterwheel 100. This means that the departing water spreads out into a larger space. This causes the water level between the sterns of the hulls 110 to be lower than the surrounding water, and allows water to be removed quickly from the waterwheel 100.

The decrease in water level at the rear R adds to the increase in water level at the front F, to increase the overall difference in water level. Thus, there is a net “fall” of water through the waterwheel 100, which increases the power output of the waterwheel 100.

The waterwheel 100 has an axle which defines a waterwheel axis A. The rotational axis of the waterwheel is arranged transversely across the pontoon P. The axle is supported by a lifting apparatus comprising two hydraulic lifting cylinders 116. Each hydraulic lifting cylinder 116 is mounted on a respective hull 110 at a hinge 118 located towards the rear R.

The hydraulic lifting cylinders 116 are operable to raise and lower the waterwheel 100, to control the extent of submersion of the waterwheel 100, which affects the power output. Hence, the power output can be controlled to suit requirements. The location of the hinge 118 towards the rear R encourages the front F to dip and biases the waterwheel 100 to “dig in” when at maximum power.

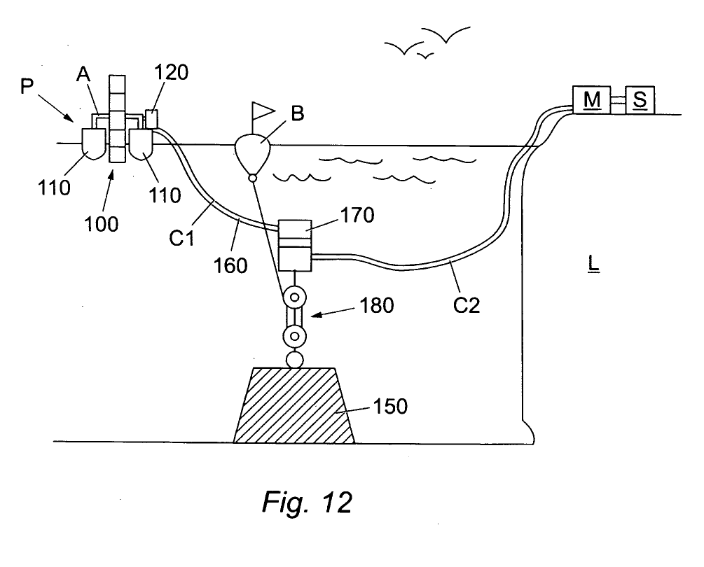

Referring to FIG. 12, the pontoon P and waterwheel 100 are shown in use on a river. The waterwheel 100 is arranged to drive a hydraulic pump 120 provided on the pontoon P. Although in this schematic diagram, the pump 120 is shown above the pontoon deck, typically, as much as possible, the pump 120, any control systems and wheel systems are below the hull deck, to reduce wind resistance.

The pontoon P is anchored to the riverbed by an anchor 150 via a tether 160.

Each hull 110 is provided with a hydraulic transmission conduit C1 supported by a respective tether 160 (only one conduit and tether shown). The tether T typically comprises a Nylon™ warp. One end of each conduit C1 is connected to the pump 120. The other end of each conduit C1 is connected to a submersible 360° free rotation coupling 170.

The coupling 170 is also connected to further hydraulic transmission conduits C2 (only one shown) that are connected to a motor M provided on land L. Hence, the hydraulic circuit between the pump 120 and the motor M is complete. The motor M drives a system S, which could be any system, for example, a heating system, a fridge, an air conditioner, a corn grinder, etc.

The hydraulic circuit comprises weak link hydraulics. Biodegradable hydraulic oil is used to safeguard the environment.

The motor M and the pump 120 can both be any suitable high pressure motor/pump, for example, a standard commercially-available agricultural high pressure hydraulic motor/pump. Alternatively, an aeronautical pump/motor could be used.

The 360° coupling allows the pontoon P and waterwheel 100 to be used, self-sufficiently and unattended, in tidal rivers or other rivers with reversing flow. By locating the hydraulic coupling 170 and the transmission conduits C1, C2 underwater, wind resistance is reduced.

A pulley 180 is located between the anchor 150 and the coupling 170. A buoy B is tethered to the pulley 180 and acts as a release to the pulley 180, so that the coupling 170 can be raised, e.g. for servicing. The buoy B also acts to caution approaching vessels.

A feedback arrangement acts to control the extent of submersion of the waterwheel 100 as a function of the power demanded by the system S. The feedback arrangement uses the pressure of the fluid returned from the motor M to determine the required extent of submergence of the waterwheel 100, and the hydraulic lifting cylinders 116 are controlled accordingly. The deeper the submerged area of the blades 12, the greater the power produced. Hence, the power obtained from the waterwheel 100 can be matched to the power demanded from the system S. Controlling the extent of submersion of the waterwheel 100 can also reduce deployment drag, and can limit stress on the arrangement in times of flood or low demand. A bypass valve ensures this is also true if the self-sealing hydraulics break. Optionally, the feedback arrangement can be arranged to raise the waterwheel 100 completely out of the water when the system S is not connected.

The present invention provides a low-cost, low-maintenance, environmentally-friendly energy generation solution. The invention has many uses, including energy generation in impoverished countries, as an alternative to unreliable diesel generators. The invention can be used to provide clean, renewable energy anywhere that a current of water is available.

Typically, the waterwheel 100 can generate a power of around 5 kW and has a working life of around 10 years.

Optionally, a small electric motor could be located on the pontoon P. The electric motor can be driven by the waterwheel 100 and used to move the pontoon P when desired.

The waterwheel 100 can optionally be provided in a self-assembly flat pack, every component of which can be manually carried.

Modifications and improvements may be incorporated without departing from the scope of the invention.

For example, the blades 12 need not have a parabolic curvature. Other shapes, for example, circular curvatures can also cause the amount of water lifted by the paddle 10 on leaving the water to be reduced, and hence are also energy-efficient.

The 360° free rotation coupling is not essential. A simple anchor and tether could suffice for constant direction water flow.

The drawings are not to scale. The hull shape of FIG. 10 is merely one example of a shape that achieves an aerofoil function; other shapes could also be used. In particular, the hulls 110 could be thinner and more angular than shown in FIG. 10.

The hulls do not necessarily have either tapered sterns or tapered bows, or both. If the hulls have only tapered bows or only tapered sterns, there is still a difference in water level causing the water to “fall down” through the waterwheel 100.

Modifications and alterations can be made without departing from the scope of the invention.

What is claimed is:

1. An undershot waterwheel having a rotational axis and paddles rotatable about the rotational axis, wherein at least one paddle comprises a blade that is curved when viewed parallel to the rotational axis, and wherein the curvature is a parabola.

2. A waterwheel as claimed in claim 1, wherein the parabola is arranged such that a trailing face of the blade is concave.

3. A waterwheel as claimed in claim 1, wherein a leading face of the blade is provided with a nose that extends from the blade.

4. A waterwheel as claimed in claim 3, wherein the nose is located at a radially outer tip of the blade.

5. A waterwheel as claimed in claim 3, wherein the nose is substantially pyramidal.

6. A waterwheel as claimed in claim 1, wherein the blade has a tip and wherein a lower part of the blade is shaped such that h α A³, where h=distance from the blade tip and where A=surface area of the blade between the tip and that distance.

7. A waterwheel as claimed in claim 1, wherein the blade is provided with means to vary the effective surface area of the blade.

8. A waterwheel as claimed in claim 7, wherein the blade has a flap valve moveable to alter the surface area of the blade.

9. A waterwheel as claimed in claim 1, wherein the paddle has a cover plate extending from the trailing face of the blade.

10. A waterwheel as claimed in claim 9, wherein the cover plate has vent holes.

11. A waterwheel as claimed in claim 9, wherein the paddle includes side panels extending from the trailing face of the blade, between the cover plate and the blade.

12. A waterwheel as claimed in claim 11, wherein the side panels are substantially triangular.

13. A watercraft including a waterwheel as claimed in claim 1.

14. A watercraft as claimed in claim 13, including two transversely spaced hulls and wherein the waterwheel is mounted between the two hulls.

15. A watercraft as claimed in claim 14, wherein the hulls are shaped such that the flowpath along the outwardly-facing sidewall of each hull is greater than the flowpath along the inwardly-facing sidewall.

16. A watercraft as claimed in claim 14, wherein, at the front of the watercraft, the hulls are shaped such that the separation of the inwardly-facing sidewalls of the hulls decreases with distance towards the waterwheel.

17. A watercraft as claimed in claim 14, wherein, at the rear of the watercraft, the hulls are shaped such that the separation of the inwardly-facing sidewalls of the hulls increases with distance away from the waterwheel.

18. A watercraft as claimed in claim 13, wherein the watercraft includes lifting apparatus adapted to raise and lower the waterwheel.

19. A watercraft as claimed in claim 18, including a control system adapted to operate the lifting apparatus to raise and lower the waterwheel in dependence on a feedback signal from a load.

20. A watercraft as claimed in claim 13, wherein the watercraft includes a hydraulic pump, and wherein the waterwheel is arranged to drive the hydraulic pump.

21. A watercraft as claimed in claim 20, including hydraulic transmission conduits and a submersible hydraulic coupling.

22. A watercraft as claimed in claim 21, wherein the submersible hydraulic coupling comprises a free rotational hydraulic coupling adapted for rotation through 3600.

23. A watercraft as claimed in claim 21, wherein the watercraft includes an anchor and at least one tether, and wherein the tether is adapted, in use, to support at least one of the hydraulic transmission conduits.

24. A watercraft as claimed in claim 23, including a pulley system adapted to couple the hydraulic coupling to the anchor, wherein the pulley system is operable to raise and lower the hydraulic coupling.

25. A watercraft as claimed in claim 24, including a release mechanism to operate the pulley to raise the hydraulic coupling.

26. An undershot waterwheel having a rotational axis and paddles rotatable about the rotational axis, wherein at least one paddle comprises a blade, and wherein a leading surface of the blade is provided with a nose that extends from the blade.

27. A watercraft having two transversely spaced hulls and an undershot waterwheel mounted between the two hulls, wherein the hulls are shaped such that the flowpath along the outwardly-facing sidewall of each hull is greater than the flowpath along the inwardly-facing sidewall.

28. An undershot waterwheel having a rotational axis and paddles rotatable about the rotational axis, wherein at least one paddle comprises a blade that is curved when viewed parallel to the rotational axis, and wherein the curvature is such as to reduce lift of water on exit of the blade from the water.
